(19) United States
(12) Patent Application Publication
(10) Pub. No.: US 2013/0212624 A1
(43) Pub. Date: Aug. 15, 2013

(54) PROGRAM GUIDE DISPLAY DEVICE, PROGRAM GUIDE DISPLAY METHOD, AND PROGRAM GUIDE DISPLAY PROGRAM

(71) Applicant: Asami OKADA, Tokyo (JP)

(72) Inventor: Asami OKADA, Tokyo (JP)

(21) Appl. No.: 13/683,862

(22) Filed: Nov. 21, 2012

(30) Foreign Application Priority Data
Feb. 13, 2012 (JP) 2012-28248

(51) Int. Cl. H04N 21/482

(52) U.S. Cl. CPC H04N 21/482
USPC 725/52

(57) ABSTRACT

Disclosed is a program guide display device including: a cursor display part 4 for displaying a cursor which is a mark indicating a cell currently being selected from among cells associated with a plurality of programs which construct an electronic program guide in a vicinity of the cell; a moving operation receiving part 5 for receiving an operation of moving the cursor; and a cursor control part 6 for, when a direction of movement of the operation received by the moving operation receiving part 5 is a rightward or leftward direction of the electronic program guide, outputting a command for moving a display position of the cursor in the rightward or leftward direction without changing a coordinate in an upward or downward direction of the cursor to the cursor display part 4 to change the cell currently being selected from one cell to another.

### BACKGROUND OF THE INVENTION

1. Field of the Invention

The present invention relates to a program guide display device for, a program guide display method of, and a program guide display program for displaying, for example, a TV electronic program guide.

2. Description of Related Art

A conventional program guide display device displays a cell currently being selected among cells associated with a plurality of programs which construct an electronic program guide in a color different from those in which the other cells are displayed, thereby enabling the user to identify the program currently being selected. Because such a conventional program guide display device displays an electronic program guide in a form in which cells associated with programs can have different sizes (different lengths in an upward or downward direction because the broadcast times of the programs can differ from one another), a movement of a cursor indicating the current selection of a program in a rightward or leftward direction causes such a zigzag movement of the cursor as shown in FIG. 15. Further, there can be a case in which there exist two or more programs to the right of the program currently being selected. In such a case, when a movement of the cursor indicating the current selection in a rightward direction is made, the user cannot predict which one of the two or more programs is selected the next time.

The following patent reference 1 discloses a program guide display device which sets cells associated with a plurality of programs which construct an electronic program guide to have a fixed size, and, even when a movement of a cursor indicating the current selection of a program in a rightward or leftward direction is made, prevents the cursor indicating the current selection from moving upward or downward in a zigzag way. However, because this conventional program guide display device sets the cells to have a fixed size, the user cannot intuitively grasp the length (broadcast time) of each program even when the user looks at the corresponding cell.

### RELATED ART DOCUMENT

### Patent Reference

Patent reference 1: Japanese Unexamined Patent Application Publication No. 2005-20246 (paragraph number [0014] and FIG. 3)

Because conventional program guide display devices are constructed as above, a problem is that a movement of a cursor indicating the current selection of a program in a rightward or leftward direction causes a zigzag movement of the cursor indicating the current selection, and, as a result, the program guide presented for the user is hard to look at. A further problem is that in the case in which there exist two or more programs adjacent to the program currently being selected, when a movement of the cursor indicating the current selection is made, the user cannot predict which one of the two or more programs is selected the next time and hence gets stressed out.

### SUMMARY OF THE INVENTION

The present invention is made in order to solve the above-mentioned problems, and it is therefore an object of the present invention to provide a program guide display device, a program guide display method and a program guide display program which prevents a cursor from moving upward or downward in a zigzag way at the time of selection of a program, thereby being able to present a legible program guide.

In accordance with the present invention, there is provided a program guide display device including: a program guide display unit for displaying an electronic program guide; a cursor display unit for displaying a cursor which is a mark indicating a cell currently being selected from among cells associated with a plurality of programs which construct the electronic program guide displayed by the program guide display unit in a vicinity of the above-mentioned cell; a moving operation receiving unit for receiving an operation of moving the cursor; and a cursor control unit for, when a direction of movement of the operation received by the moving operation receiving unit is a rightward or leftward direction of the electronic program guide, outputting a command for moving a display position of the cursor in the rightward or leftward direction without changing a coordinate in an upward or downward direction of the cursor to the cursor display unit to change the cell currently being selected from one cell to another.

Because the program guide display device according to the present invention includes: the program guide display unit for displaying an electronic program guide; the cursor display unit for displaying a cursor which is a mark indicating a cell currently being selected from among cells associated with a plurality of programs which construct the electronic program guide displayed by the program guide display unit in a vicinity of the above-mentioned cell; the moving operation receiving unit for receiving an operation of moving the cursor; and the cursor control unit for, when a direction of movement of the operation received by the moving operation receiving unit is a rightward or leftward direction of the electronic program guide, outputting a command for moving a display position of the cursor in the rightward or leftward direction without changing a coordinate in an upward or downward direction of the cursor to the cursor display unit to change the cell currently being selected from one cell to another, there is provided an advantage of preventing the cursor from moving upward or downward in a zigzag way at the time of selection of a program, thereby being able to present the electronic program guide in a legible manner.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing a program guide display device in accordance with Embodiment 1 of the present invention;

FIG. 2 is a flow chart showing processing (program guide display method) carried out by the program guide display device in accordance with Embodiment 1 of the present invention;

FIG. 3 is an explanatory drawing showing a display example of an electronic program guide;

FIG. 4 is an explanatory drawing showing an example of a display of a cursor;

FIG. 5 is an explanatory drawing showing an example in which the display position of the cursor is moved rightward and a cell currently being selected is changed to a program of F TV;

FIG. 6 is an explanatory drawing showing an example in which the display position of the cursor is moved downwardly and the cell currently being selected is changed to a program of D TV;

FIG. 7 is an explanatory drawing showing an example of the shape of the cursor;

FIG. 8 is a block diagram showing a program guide display device in accordance with Embodiment 2 of the present invention;

FIG. 9 is an explanatory drawing showing an example of adjustment of a coordinate in an upward or downward direction of the cursor;

FIG. 10 is a block diagram showing a program guide display device in accordance with Embodiment 3 of the present invention;

FIG. 11 is an explanatory drawing showing an example in which the display position of an electronic program guide is moved leftward and the cell currently being selected is changed to a program of G TV;

FIG. 12 is an explanatory drawing showing an example in which the display position of the electronic program guide is moved upwardly because an upper part of a cell extends off a predetermined display area;

FIG. 13 is an explanatory drawing showing information associated with a program displayed in a cursor;

FIG. 14 is an explanatory drawing showing an example in which the cell currently being selected by a free cursor is changed from one cell to another; and

FIG. 15 is an explanatory drawing showing a change of the current selection of a program.

### DETAILED DESCRIPTION OF THE PREFERRED EMBODIMENTS

### Embodiment 1

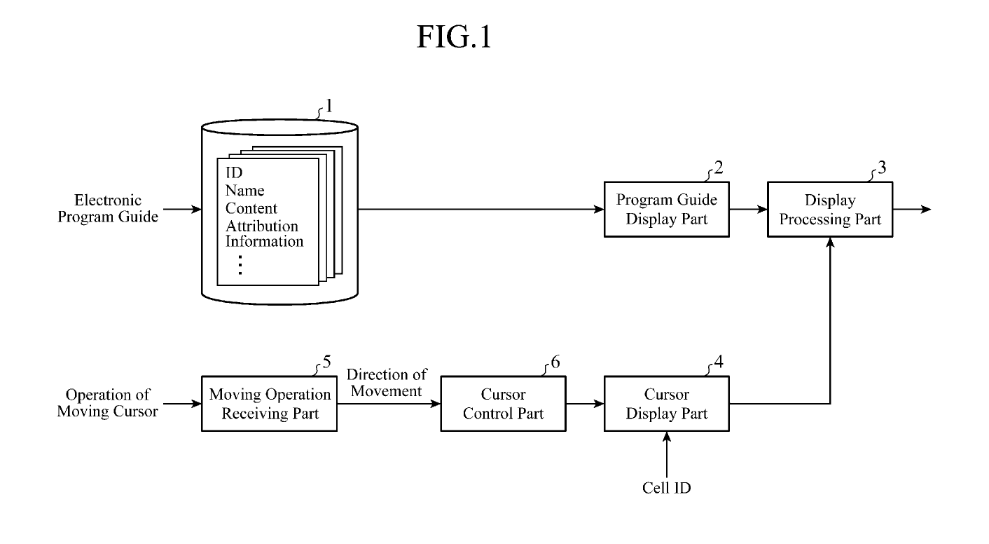

FIG. 1 is a block diagram showing a program guide display device in accordance with Embodiment 1 of the present invention. In FIG. 1, a cell information storage part 1 consists of, for example, a recording unit, such as a RAM or a hard disk. The cell information storage part 1 collects a TV electronic program guide which is received by, for example, AV equipment, such as a television, and stores cell information which is information about cells associated with a plurality of programs which construct the electronic program guide therein. This cell information includes a program ID (cell ID) for identifying each program, the name of each program (program title), the content of each program (detailed information about each program), and attribution information showing the genre of each program and so on.

A program guide display part 2 consists of, for example, an integrated circuit in which a CPU is mounted, or a one chip microcomputer, and carries out a process of referring to the cell information stored in the cell information storage part 1 to generate image data showing the electronic program guide, and outputting the image data to a display processing part 3. The display processing part 3 consists of, for example, a GPU (Graphics Processing Unit), and carries out a process of displaying the TV electronic program guide on a not-shown display according to the image data outputted thereto from the program guide display part 2. A program guide display unit is comprised of the program guide display part 2 and the display processing part 3.

A cursor display part 4 consists of, for example, an integrated circuit in which a CPU is mounted, or a one chip microcomputer, and carries out a process of outputting a command for displaying a cursor which is a mark indicating the cell currently being selected among the cells associated with the plurality of programs which construct the electronic program guide displayed by the display processing part 3 in the vicinity of the above-mentioned cell to the display processing part 3. A cursor display unit is comprised of the cursor display part 4 and the display processing part 3.

A moving operation receiving part 5 consists of interface unit equipment (e.g., an infrared ray interface circuit or a LAN interface circuit) for acquiring information from, for example, a remote control, the AV equipment, or the like, a semiconductor integrated circuit in which a CPU is mounted, and so on. The moving operation receiving part 5 carries out a process of receiving an operation of moving the cursor according to the information acquired thereby. The moving operation receiving part 5 constructs a moving operation receiving unit. A cursor control part 6 consists of, for example, an integrated circuit in which a CPU is mounted, or a one chip microcomputer, and carries out a process of, when the direction of movement of the operation received by the moving operation receiving part 5 is a rightward or leftward direction of the electronic program guide, outputting a command for moving the display position of the cursor in the rightward or leftward direction without changing a Y coordinate (a coordinate in an upward or downward direction) of the cursor to the cursor display part 4 to change the cell currently being selected from one cell to another. The cursor control part 6 constructs a cursor control unit.

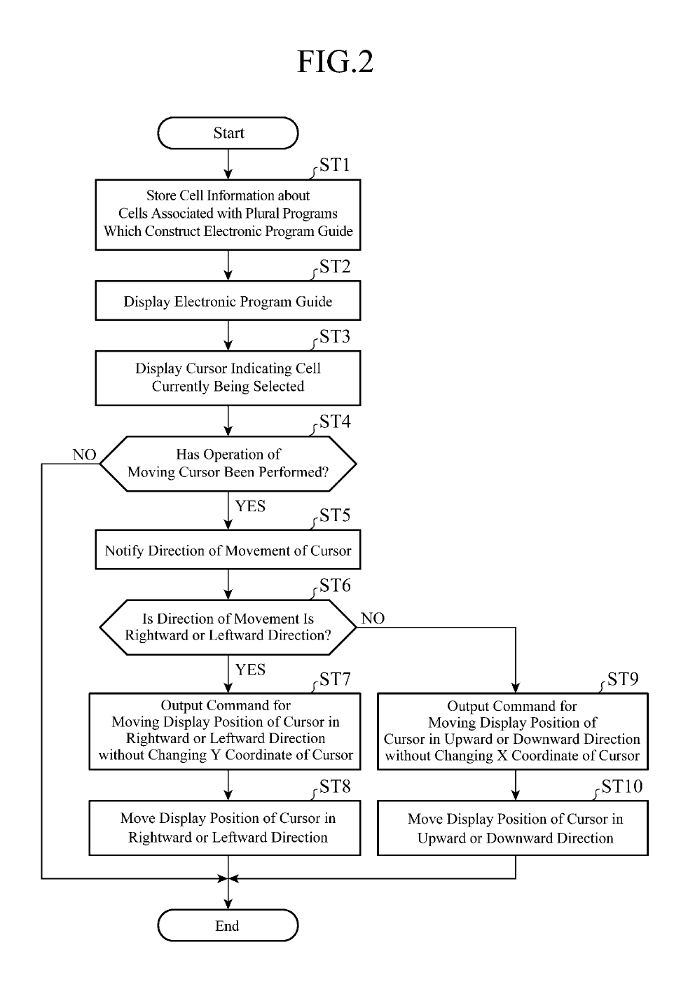

Although it is assumed in the example of FIG. 1 that the cell information storage part 1, the program guide display part 2, the display processing part 3, the cursor display part 4, the moving operation receiving part 5, and the cursor control part 6, which are the components of the program guide display device, consist of pieces of hardware for exclusive use, respectively, the program guide display device can alternatively consist of a computer. In the case in which the program guide display device consists of a computer, the cell information storage part 1 can be formed in a memory of the computer while a program guide display program in which the processes carried out by the program guide display part 2, the display processing part 3, the cursor display part 4, the moving operation receiving part 5, and the cursor control part 6 are described can be stored in the memory of the computer, a CPU of the computer can be made to execute the program guide display program stored in the memory, for example. FIG. 2 is a flow chart showing processing (program guide display method) carried out by the program guide display device in accordance with Embodiment 1 of the present invention.

Next, the operation of the program guide display device will be explained. First, a TV electronic program guide received by the AV equipment, such as a television, is sent to the cell information storage part 1, and the cell information about cells associated with a plurality of programs which construct the electronic program guide is stored in the cell information storage part 1 (step ST1 of FIG. 2). At this time, this cell information includes a program ID (cell ID) for identifying each of the programs, the name of each of the programs (program title), the content of each of the programs, and attribution information showing the genre of each of the programs and so on.

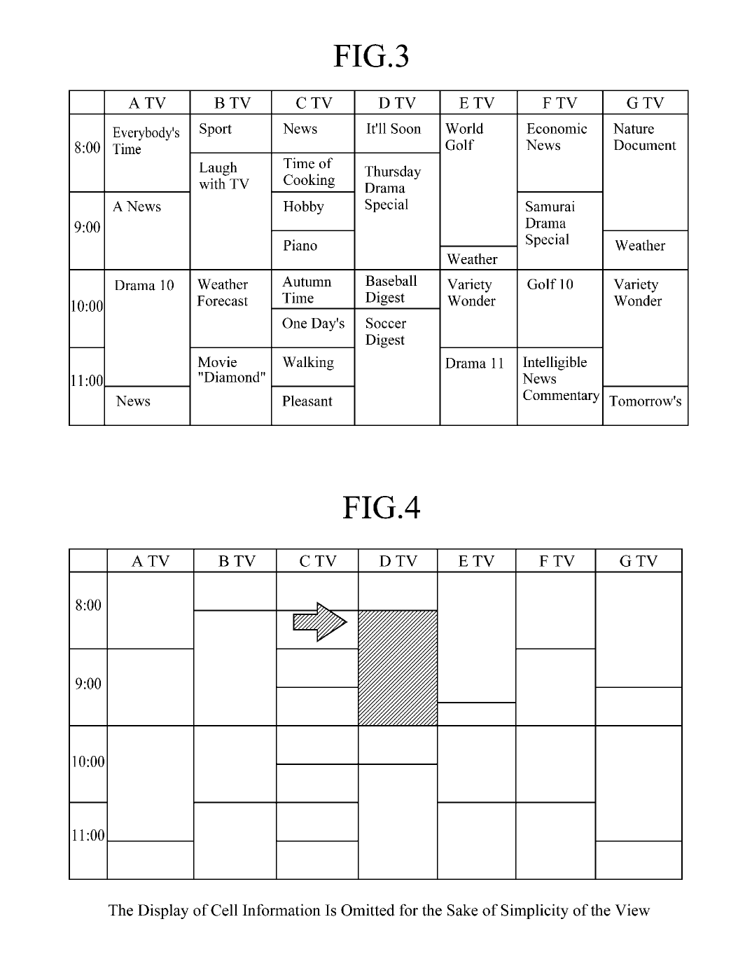

The program guide display part 2 refers to the cell information stored in the cell information storage part 1 to generate image data showing the electronic program guide, and outputs the image data to the display processing part 3. When receiving the image data from the program guide display part 2, the display processing part 3 displays the TV electronic program guide on a not-shown display according to the image data, as shown in FIG. 3 (step ST2).

The cursor display part 4 acquires a cell ID showing a cell currently being selected from among the cells associated with the plurality of programs which construct the electronic program guide from, for example, the remote control, the AV equipment, or the like. When acquiring the cell ID showing the cell currently being selected, the cursor display part 4 outputs a command for displaying a cursor indicating the cell shown by the cell ID (i.e. the cell currently being selected) in the vicinity of the above-mentioned cell to the display processing part 3, as shown in FIG. 4. As a result, the display processing part 3 displays the cursor indicating the cell currently being selected in the vicinity of the above-mentioned cell, as shown in FIG. 4 (step ST3).

When the user carries out an operation of moving the cursor by using, for example, the remote control (step ST4), the moving operation receiving part 5 receives the operation of moving the cursor, and then notifies the direction of movement of the cursor to the cursor control part 6 (step ST5).

In response to the notification of the direction of movement of the cursor from the moving operation receiving part 5, when the direction of movement is the rightward or leftward direction of the electronic program guide (step ST6), the cursor control part 6 outputs a command for moving the display position of the cursor straight forward in the rightward or leftward direction without changing the Y coordinate of the cursor (the coordinate of the cursor in an upward or downward direction) to the cursor display part 4 to change the cell currently being selected from one cell to another (step ST7). When receiving the command for moving the display position of the cursor straight forward in the rightward or leftward direction from the cursor control part 6, the cursor display part 4 controls the display processing part 3 to move the display position of the cursor straight forward in the rightward or leftward direction (step ST8).

FIG. 5 is an explanatory drawing showing an example in which the display position of the cursor is moved rightward to change the cell currently being selected to a program of F TV. In the example of FIG. 5, because the Y coordinate of the cursor is not being changed, the cursor is moving while pointing to cells at the same time associated with different television stations.

When the direction of movement of the cursor is the upward or downward direction of the electronic program guide (step ST6), the cursor control part 6 outputs a command for moving the display position of the cursor in the upward or downward direction without changing the X coordinate of the cursor (the coordinate in the rightward or leftward direction) to the cursor display part 4 to change the cell currently being selected from one cell to another (step ST9). When receiving the command for moving the display position of the cursor in the upward or downward direction from the cursor control part 6, the cursor display part 4 controls the display processing part 3 to move the display position of the cursor in the upward or downward direction (step ST10).

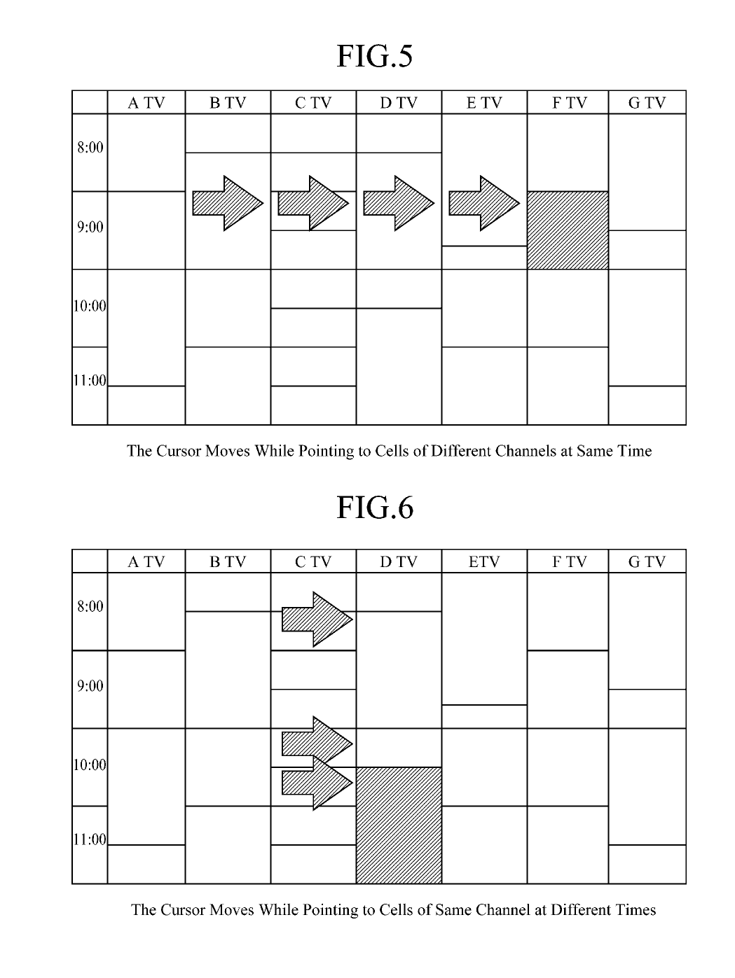

FIG. 6 is an explanatory drawing showing an example in which the display position of the cursor is moved downwardly and the cell currently being selected is changed to a subsequent program of D TV. In the example of FIG. 6, because the X coordinate of the cursor is not being changed, the cursor is moving while pointing to cells at different times associated with the same television station.

As can be seen from the above description, because the program guide display device according to this Embodiment 1 is constructed in such a way as to include: the program guide display part 2 for displaying an electronic program guide; the cursor display part 4 for displaying a cursor indicating a cell currently being selected among cells associated with a plurality of programs which construct the electronic program guide displayed by the program guide display part 2 in the vicinity of the above-mentioned cell; the moving operation receiving part 5 for receiving an operation of moving the cursor; and the cursor control part 6 for, when the direction of movement of the operation received by the moving operation receiving part 5 is a rightward or leftward direction of the electronic program guide, outputting a command for moving the display position of the cursor in the rightward or leftward direction without changing a coordinate in an upward or downward direction of the cursor to the cursor display part 4 to change the cell currently being selected from one cell to another, there is provided an advantage of preventing the cursor from moving upward or downward in a zigzag way at the time of selection of a program, thereby being able to present the program guide in a legible manner. There is provided a further advantage of, even when there exist two or more programs adjacent to the program currently being selected, enabling the user to easily predict which program is selected the next time.

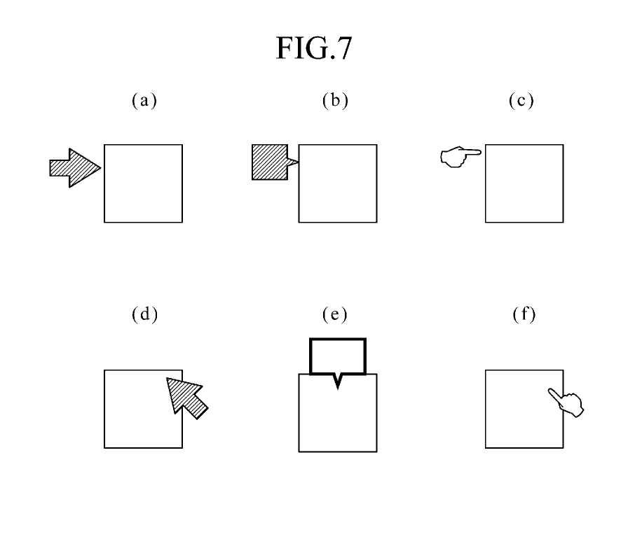

Although in this Embodiment 1 the example in which the shape of the cursor is a right arrow as shown in FIG. 7(a) is shown, the shape of the cursor is not limited to such a right arrow. For example, the cursor can have a shape as shown in any one of FIGS. 7(b) to 7(f).

### Embodiment 2

Although in above-mentioned Embodiment 1 the example in which when the direction of movement of an operation received by the moving operation receiving part 5 is the rightward or leftward direction of the electronic program guide, the display position of the cursor is moved straight forward in the rightward or leftward direction without changing the coordinate in the upward or downward direction of the cursor is shown, when an operation of moving the cursor is not received by the moving operation receiving part 5 during a time interval (e.g. 0.5 seconds) after a command for moving the display position of the cursor in the rightward or leftward direction has been outputted to the cursor display part 4, the coordinate in the upward or downward direction of the cursor can be adjusted.

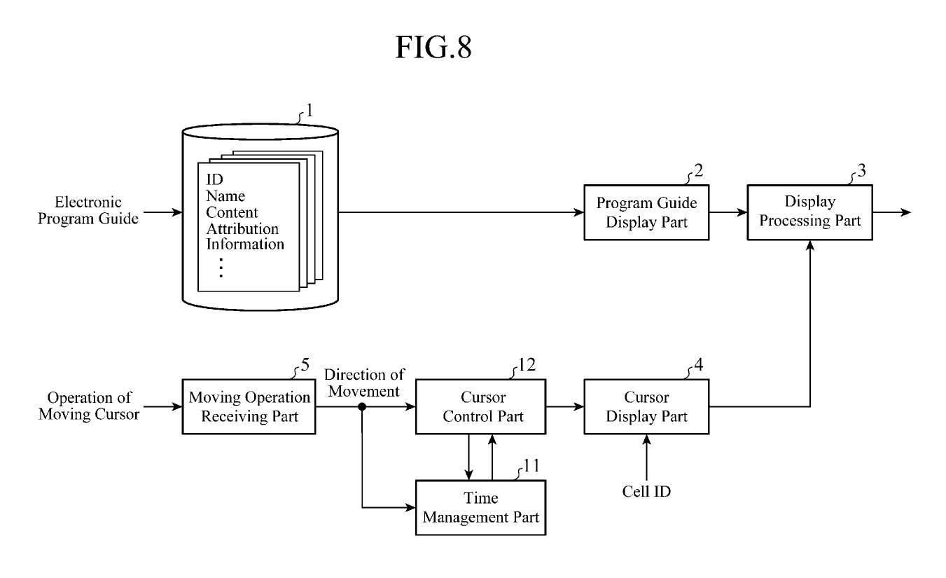

FIG. 8 is a block diagram showing a program guide display device in accordance with Embodiment 2 of the present invention. In the figure, because the same reference numerals as those shown in FIG. 1 denote the same components or like components, the explanation of the components will be omitted hereafter. A time management part 11 consists of, for example, a timer, and carries out a process of counting a time which has elapsed since a command for moving the display position of a cursor in a rightward or leftward direction was outputted from a cursor control part 12, and for, when an operation of moving the cursor is received by a moving operation receiving part 5, resetting the counted value showing the elapsed time, and for, when the counted value showing the elapsed time reaches a predetermined value, notifying the cursor control part 12 to that effect.

The cursor control part 12 consists of, for example, an integrated circuit in which a CPU is mounted, or a one chip microcomputer, and carries out a process of, when the direction of movement of the operation received by the moving operation receiving part 5 is a rightward or leftward direction of an electronic program guide, outputting a command for moving the display position of the cursor straight forward in the rightward or leftward direction without changing a Y coordinate (a coordinate in an upward or downward direction) of the cursor to a cursor display part 4 to change a cell currently being selected from one cell to another, like the cursor control part 6 shown in FIG. 1. The cursor control part 12 also carries out a process of adjusting the Y coordinate (the coordinate in the upward or downward direction) of the cursor when receiving the notification indicating that the counted value showing the elapsed time has reached the predetermined value from the time management part 11, unlike the cursor control part 6 shown in FIG. 1. A cursor control unit is comprised of the time management part 11 and the cursor control part 12.

Although it is assumed in the example of FIG. 8 that a cell information storage part 1, a program guide display part 2, a display processing part 3, the cursor display part 4, the moving operation receiving part 5, the time management part 11, and the cursor control part 12, which are the components of the program guide display device, consist of pieces of hardware for exclusive use, respectively, the program guide display device can alternatively consist of a computer. In the case in which the program guide display device consists of a computer, the cell information storage part 1 can be formed in a memory of the computer while a program guide display program in which the processes carried out by the program guide display part 2, the display processing part 3, the cursor display part 4, the moving operation receiving part 5, the time management part 11, and the cursor control part 12 are described can be stored in the memory of the computer, a CPU of the computer can be made to execute the program guide display program stored in the memory, for example.

Next, the operation of the program guide display device will be explained. Because the processes except those carried out by the time management part 11 and the cursor control part 12 are the same as those carried out by the program guide display device in accordance with above-mentioned Embodiment 1, the processes carried out by the time management part 11 and the cursor control part 12 will be mainly explained hereafter.

In response to a notification of the direction of movement of the cursor from the moving operation receiving part 5, when the direction of movement is the rightward or leftward direction of the electronic program guide, the cursor control part 12 outputs a command for moving the display position of the cursor straight forward in the rightward or leftward direction without changing the Y coordinate of the cursor (the coordinate of the cursor in the upward or downward direction) to the cursor display part 4 to change the cell currently being selected from one cell to another, like the cursor control part 6 shown in FIG. 1. When receiving the command for moving the display position of the cursor straight forward in the rightward or leftward direction from the cursor control part 6, the cursor display part 4 controls the display processing part 3 to move the display position of the cursor straight forward in the rightward or leftward direction.

When the direction of movement of the cursor is the upward or downward direction of the electronic program guide, the cursor control part 12 outputs a command for moving the display position of the cursor in the upward or downward direction without changing the X coordinate of the cursor (the coordinate in the rightward or leftward direction) to the cursor display part 4 to change the cell currently being selected from one cell to another. When receiving the command for moving the display position of the cursor in the upward or downward direction from the cursor control part 12, the cursor display part 4 controls the display processing part 3 to move the display position of the cursor in the upward or downward direction.

When outputting the command for moving the display position of the cursor in the rightward or leftward direction to the cursor display part 4, the cursor control part 12 outputs a command for starting counting an elapsed time to the time management part 11, unlike the cursor control part 6 shown in FIG. 1.

When receiving the command for starting counting an elapsed time from the cursor control part 12, the time management part 11 starts a timer not shown in the figure and then starts counting an elapsed time. After starting counting an elapsed time, the time management part 11 resets the counted value showing the elapsed time when an operation of moving the cursor is received by the moving operation receiving part 5, and, when the direction of movement of the cursor is the rightward or leftward direction, starts counting an elapsed time again. In contrast, when the direction of movement of the cursor is the upward or downward direction, the time management part 11 ends the counting of an elapsed time.

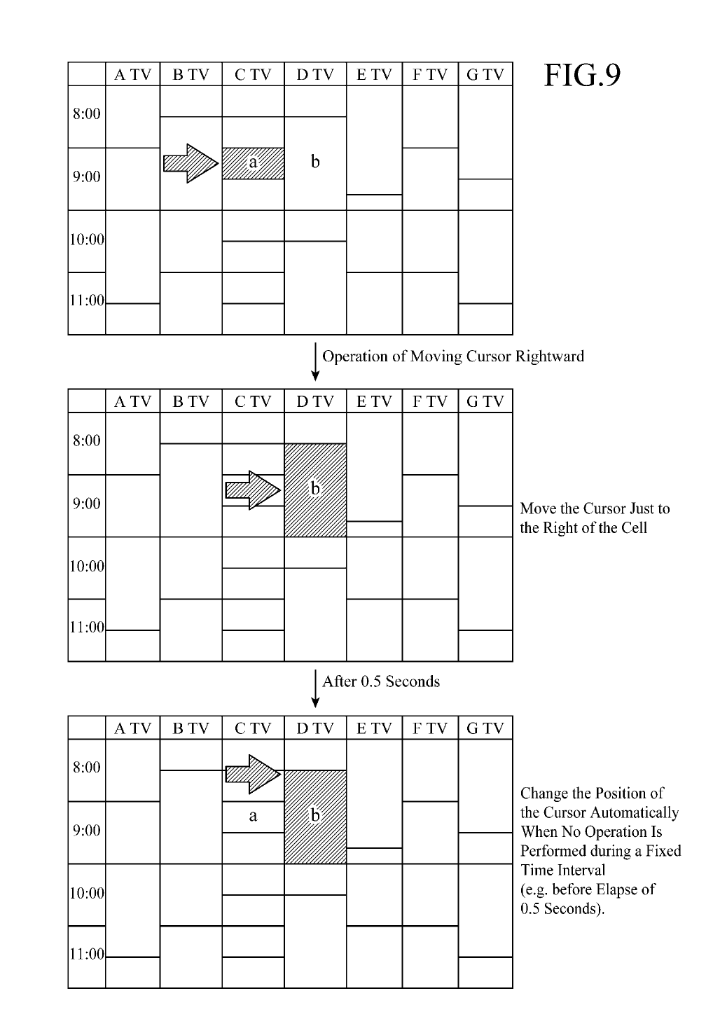

After starting counting an elapsed time, when the moving operation receiving part 5 does not receive any operation of moving the cursor and the counted value showing the elapsed time reaches a predetermined value (e.g. 0.5 seconds), the time management part 11 notifies the cursor control part 12 to that effect. When receiving the notification indicating that the counted value showing the elapsed time has reached the predetermined value from the time management part 11, the cursor control part 12 adjusts the coordinate in the upward or downward direction of the cursor. FIG. 9 is an explanatory drawing showing an example of the adjustment of the coordinate in the upward or downward direction of the cursor. In the example shown in FIG. 9, the position pointed to by the cursor is adjusted in such a way as to have the same height as the position where the character at the head of the character string showing the name of the program to which the current selection has been changed is displayed.

As can be seen from the above description, because the program guide display device in accordance with this Embodiment 2 can be constructed in such a way as to, when the moving operation receiving part 5 does not receive any operation of moving the cursor during a time interval (e.g. 0.5 seconds) after the cursor control part 12 has outputted a command for moving the display position of the cursor in the rightward or leftward direction to the cursor display part 4, adjust the coordinate in the upward or downward direction of the cursor, there is provided an advantage of enabling the user to identify the cell pointed to by the cursor at the time that it can be assumed that an operation of moving the cursor in the rightward or leftward direction is completed.

### Embodiment 3

Although in above-mentioned Embodiment 1 the example in which when the direction of movement of an operation received by the moving operation receiving part 5 is the rightward or leftward direction of the electronic program guide, the display position of the cursor is moved straight forward in the rightward or leftward direction without changing the coordinate in the upward or downward direction of the cursor is shown, when predicting that the output of a command for moving the display position of the cursor in the rightward or leftward direction to the cursor display part 4 will result in the display position of the cursor going off a predetermined display area, the program guide display device can output a command for moving the display position of the electronic program guide in the rightward or leftward direction to the program guide display part 2 instead of outputting the command for moving the display position of the cursor in the rightward or leftward direction to the cursor display part 4.

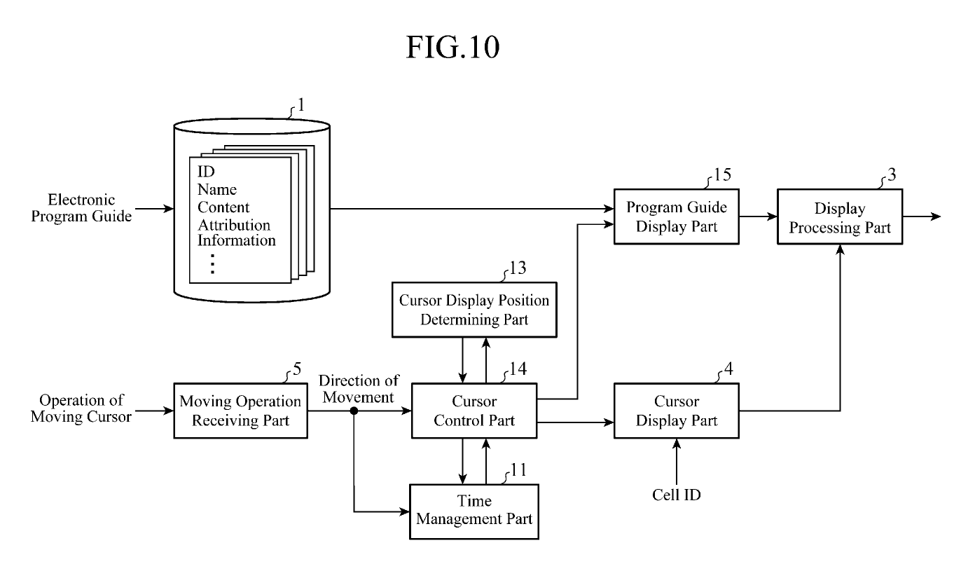

FIG. 10 is a block diagram showing a program guide display device in accordance with Embodiment 3 of the present invention. In the figure, because the same reference numerals as those shown in FIG. 8 denote the same components or like components, the explanation of the components will be omitted hereafter. A cursor display position determining part 13 consists of, for example, an integrated circuit in which a CPU is mounted, or a one chip microcomputer, and carries out a process of, when a cursor control part 14 outputs a command for moving the display position of a cursor in a rightward or leftward direction to a cursor display part 4 to change a cell currently being selected from one cell to another, determining whether or not the other cell to which the current selection is changed is located outside a predetermined display area.

The cursor control part 14 consists of, for example, an integrated circuit in which a CPU is mounted, or a one chip microcomputer, and carries out a process of, when the cursor display position determining part 13 determines that the other cell to which the current selection is changed is located outside the predetermined display area, outputting a command for moving the display position of the electronic program guide in the rightward or leftward direction to a program guide display part 15 instead of outputting the command for moving the display position of the cursor in the rightward or leftward direction to the cursor display part 4, in addition to carrying out the same process as that carried out by the cursor control part 12 shown in FIG. 8. A cursor control unit is comprised of a time management part 11, the cursor display position determining part 13, and the cursor control part 14.

The program guide display part 15 consists of, for example, an integrated circuit in which a CPU is mounted, or a one chip microcomputer, and carries out a process of referring to cell information stored in a cell information storage part 1 to generate image data showing the electronic program guide, and outputs the image data to a display processing part 3, like the program guide display part 2 shown in FIG. 8. The program guide display part 15 also carries out a process of, when receiving the command for moving the display position of the electronic program guide in the rightward or leftward direction from the cursor control part 14, controlling the display processing part 3 to move the display position of the electronic program guide in the rightward or leftward direction, unlike the program guide display part 2 shown in FIG. 8. A program guide display unit is comprised the program guide display part 15 and the display processing part 3.

Although it is assumed in the example of FIG. 10 that the cell information storage part 1, the program guide display part 15, the display processing part 3, the cursor display part 4, a moving operation receiving part 5, the time management part 11, the cursor display position determining part 13, and the cursor control part 14, which are the components of the program guide display device, consist of pieces of hardware for exclusive use, respectively, the program guide display device can alternatively consist of a computer. In the case in which the program guide display device consists of a computer, the cell information storage part 1 can be formed in a memory of the computer while a program guide display program in which the processes carried out by the program guide display part 15, the display processing part 3, the cursor display part 4, the moving operation receiving part 5, the time management part 11, the cursor display position determining part 13, and the cursor control part 14 are described can be stored in the memory of the computer, a CPU of the computer can be made to execute the program guide display program stored in the memory, for example.

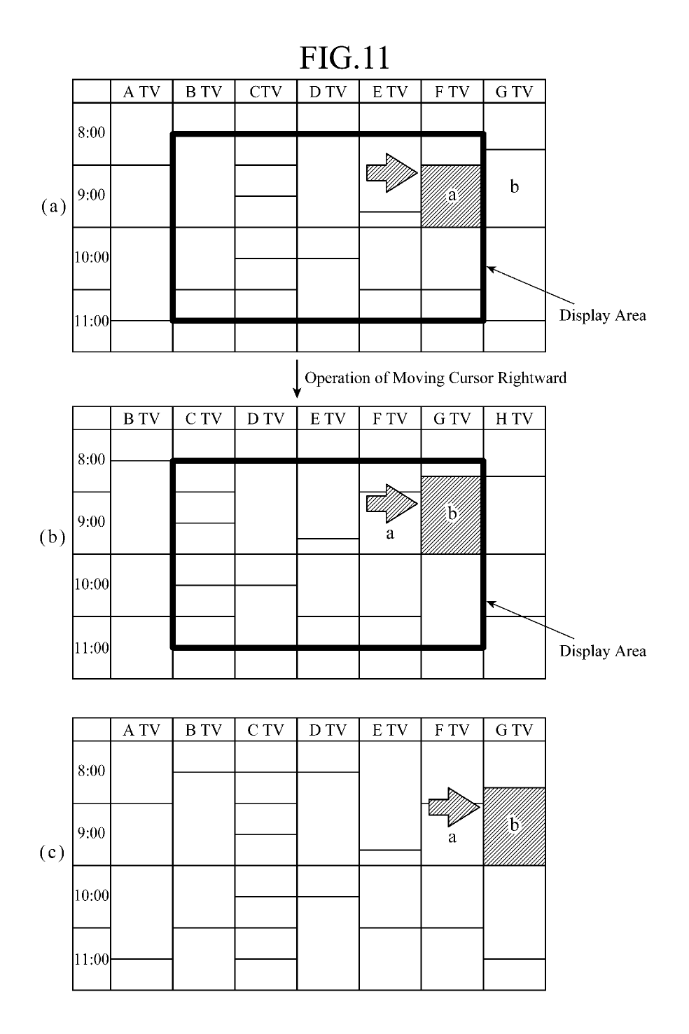

Next, the operation of the program guide display device will be explained. Because the program guide display device according to Embodiment 3 has the same components as that according to above-mentioned Embodiment 2 except for the cursor display position determining part 13 and the cursor control part 14, processes carried out by the cursor display position determining part 13 and the cursor control part 14 will be explained mainly. FIG. 11 is an explanatory drawing showing an example in which the display position of the electronic program guide is moved leftward and the currently selected cell is changed to another program of G TV. In this Embodiment 3, an explanation will be made assuming that a display area is set for the cursor, as shown in FIG. 11. The size of the display area of the cursor is arbitrary.

In response to a notification of the direction of movement of the cursor from the moving operation receiving part 5, when the direction of movement is the rightward or leftward direction of the electronic program guide, the cursor control part 14 notifies the direction of movement to the cursor display position determining part 13. The cursor display position determining part 13 manages the display position of the cell currently being selected, and, when receiving the notification of the direction of movement of the cursor from the cursor control part 14, determines whether a movement of the cursor in the direction of movement to change the cell currently being selected from one cell to another results in the other cell, to which the current selection is changed, going off the predetermined display area. When the display position of the cell currently being selected is as shown in FIG. 11(a), and the direction of movement of the cursor is the rightward direction of the electronic program guide, the cursor display position determining part 13 determines that the other cell to which the current selection is changed will go off the predetermined display area.

When the result of the determination carried out by the cursor display position determining part 13 shows that even a movement of the cursor in the rightward or leftward direction to change the cell currently being selected from one cell to another does not result in the other cell, to which the current selection is changed, going off the predetermined display area, the cursor control part 14 outputs a command for moving the display position of the cursor in the rightward or leftward direction to the cursor display part 4, like the cursor control part 12 shown in FIG. 8. In contrast, when the result of the determination carried out by the cursor display position determining part 13 shows that a movement of the cursor in the rightward or leftward direction to change the cell currently being selected from one cell to another results in the other cell, to which the current selection is changed, going off the predetermined display area, the cursor control part 14 outputs a command for moving the display position of the electronic program guide in the rightward or leftward direction to the program guide display part 15 instead of outputting the command for moving the display position of the cursor in the rightward or leftward direction to the cursor display part 4. When the current display position of the cursor is as shown in FIG. 11(a), and the direction of movement of the cursor is the rightward direction of the electronic program guide, the cursor control unit outputs a command for moving the display position of the electronic program guide leftward to the program guide display part 15.

When receiving the command for moving the display position of the electronic program guide in the rightward or leftward direction from the cursor control part 14, the program guide display part 15 controls the display processing part 3 to move the display position of the electronic program guide in the rightward or leftward direction. In the example shown in FIG. 11(b), the program guide display part moves the display position of the electronic program guide leftward to change the cell currently being selected to a program of G TV. If the cell currently being selected is changed from one up to another at the right end of the electronic program guide, as shown in FIG. 11(c), the user cannot judge whether there exist programs associated with broadcast stations to the right of the electronic program guide currently being displayed even though he or she looks at the electronic program guide. Therefore, the program guide display device according to this Embodiment 3 causes the cell currently being selected to stay in the predetermined display area.

As can be seen from the above description, because the program guide display device in accordance with this Embodiment 3 is constructed in such a way as to, when predicting that outputting a command for moving the display position of the cursor in the rightward or leftward direction to the cursor display part 4 to change the cell currently being selected from one cell to another will result in the other cell, to which the current selection is changed, going off a predetermined display area, output a command for moving the display position of the electronic program guide in the rightward or leftward direction to the program guide display part 15 instead of outputting the command for moving the display position of the cursor in the rightward or leftward direction to the cursor display part 4, there is provided an advantage of being able to prevent changing the cell currently being selected from one cell to another from resulting in the other cell to which the current selection is changed going off the predetermined display area.

### Embodiment 4

Although in above-mentioned Embodiment 3 the example in which when predicting that outputting a command for moving the display position of the cursor in the rightward or leftward direction to the cursor display part 4 to change the cell currently being selected from one cell to another will result in the other cell, to which the current selection is changed, going off a predetermined display area, the program guide display device outputs a command for moving the display position of the electronic program guide in the rightward or leftward direction to the program guide display part 15 instead of outputting the command for moving the display position of the cursor in the rightward or leftward direction to the cursor display part 4 is shown, the program guide display device can alternatively output a command for moving the display position of the cursor in the rightward or leftward direction to the cursor display part 4 while outputting a command for moving the display position of the electronic program guide in the upward or downward direction to the program guide display part 15 when predicting that outputting the command for moving the display position of the cursor in the rightward or leftward direction to the cursor display part 4 to change the cell currently being selected from one cell to another will result in an upper or lower part (part) of the other cell, to which the current selection is changed, going off the predetermined display area.

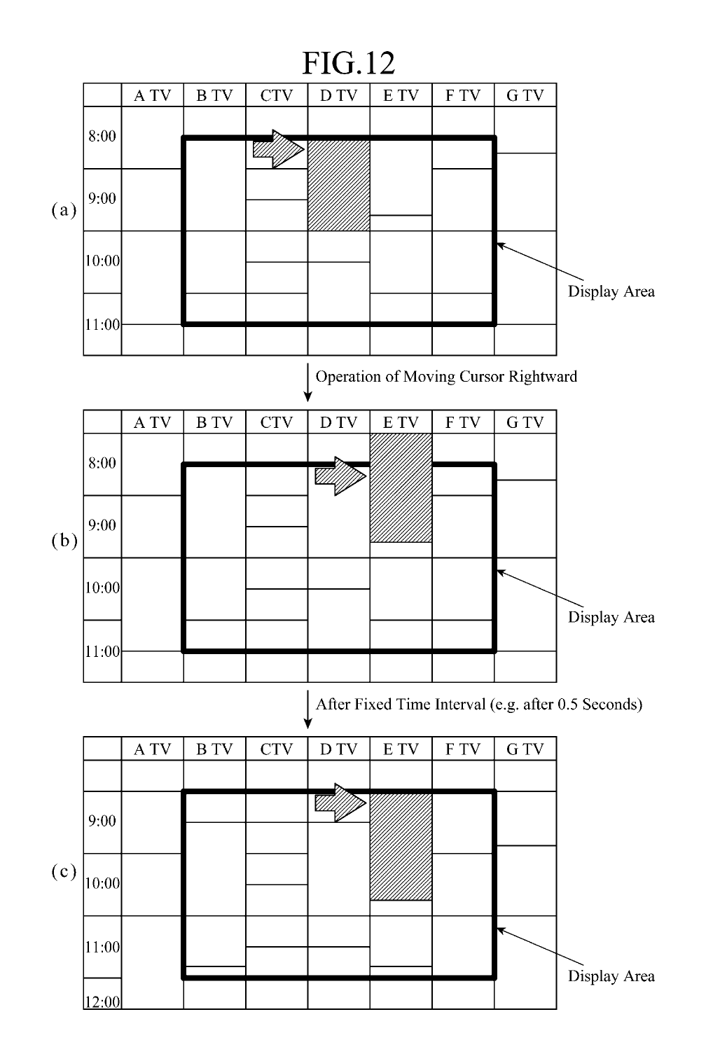

Next, the operation of the program guide display device will be explained. FIG. 12 is an explanatory drawing showing an example in which the display position of the electronic program guide is moved upwardly because an upper part of the other cell to which the current selection is changed goes off the predetermined display area. In response to a notification of the direction of movement of the cursor from the moving operation receiving part 5, when the direction of movement is the rightward or leftward direction of the electronic program guide, the cursor control part 14 notifies the direction of movement to the cursor display position determining part 13, like that according to above-mentioned Embodiment 3.

When receiving the notification of the direction of movement of the cursor from the cursor control part 14, the cursor display position determining part 13 determines whether a movement of the cursor in the direction of movement to change the cell currently being selected from one cell to another results in the other cell, to which the current selection is changed, going off the predetermined display area. The cursor display position determining part 13 further determines whether a movement of the cursor in the direction of movement to change the cell currently being selected from one cell to another results in an upper or lower part (part) of the other cell, to which the current selection is changed, going off the predetermined display area. When the current display position of the cursor is as shown in FIG. 12(a), and the direction of movement of the cursor is the rightward direction of the electronic program guide, the cursor display position determining part determines that an upper part of the other cell, to which the current selection is changed, will go off the predetermined display area.

When the result of the determination carried out by the cursor display position determining part 13 shows that even a movement of the cursor in the rightward or leftward direction to change the cell currently being selected from one cell to another does not result in the other cell, to which the current selection is changed, going off the predetermined display area, the cursor control part 14 outputs a command for moving the display position of the cursor in the rightward or leftward direction to the cursor display part 4, like the cursor control part 12 shown in FIG. 8. In contrast, when the result of the determination carried out by the cursor display position determining part 13 shows that a movement of the cursor in the rightward or leftward direction to change the cell currently being selected from one cell to another results in the other cell, to which the current selection is changed, going off the predetermined display area, the cursor control part 14 outputs a command for moving the display position of the electronic program guide in the rightward or leftward direction to the program guide display part 15 instead of outputting the command for moving the display position of the cursor in the rightward or leftward direction to the cursor display part 4. When the current display position of the cursor is as shown in FIG. 11(a), and the direction of movement of the cursor is the rightward direction of the electronic program guide, the cursor control unit outputs a command for moving the display position of the electronic program guide leftward to the program guide display part 15.

Further, when the result of the determination carried out by the cursor display position determining part 13 shows that a movement of the cursor in the rightward or leftward direction to change the cell currently being selected from one cell to another results in an upper or lower part (part) of the other cell, to which the current selection is changed, going off the predetermined display area, the cursor control part 14 outputs a command for moving the display position of the cursor in the rightward or leftward direction to the cursor display part 4 while outputting a command for moving the display position of the electronic program guide in the upward or downward direction to the program guide display part 15. When receiving the command for moving the display position of the cursor in the rightward or leftward direction from the cursor control part 14, the cursor display part 4 controls the display processing part 3 to move the display position of the cursor in the rightward or leftward direction. As a result, the display position of the cell currently being selected is changed from a position shown in FIG. 12(a) to another position shown in FIG. 12(b).

When receiving the command for moving the display position of the electronic program guide in the upward or downward direction from the cursor control part 14, the program guide display part 15 controls the display processing part 3 to move the display position of the electronic program guide in the upward or downward direction. In an example shown in FIG. 12(c), the program guide display part moves the display position of the electronic program guide upwardly to cause the cell currently being selected to stay in the predetermined display area.

As can be seen from the above description, the program guide display device in accordance with this Embodiment 4 is constructed in such a way as to, when predicting that outputting a command for moving the display position of the cursor in the rightward or leftward direction to the cursor display part 4 to change the cell currently being selected from one cell to another will result in an upper or lower part (part) of the other cell, to which the current selection is changed, going off a predetermined display area, output a command for moving the display position of the cursor in the rightward or leftward direction to the cursor display part 4 while outputting a command for moving the display position of the electronic program guide in the upward or downward direction to the program guide display part 15, there is provided an advantage of being able to prevent changing the cell currently being selected from one cell to another from resulting in the other cell to which the current selection is changed going off the predetermined display area.

Although in this Embodiment 4 the example in which the cursor control part 14 outputs a command for moving the display position of the cursor in the rightward or leftward direction to the cursor display part 4 while outputting a command for moving the display position of the electronic program guide in the upward or downward direction to the program guide display part 15 is shown, the cursor control part 14 can alternatively output the command for moving the display position of the electronic program guide in the upward or downward direction to the program guide display part 15 when a fixed time interval (e.g. 0.5 seconds) has elapsed after outputting the command for moving the display position of the cursor in the rightward or leftward direction to the cursor display part 4.

### Embodiment 5

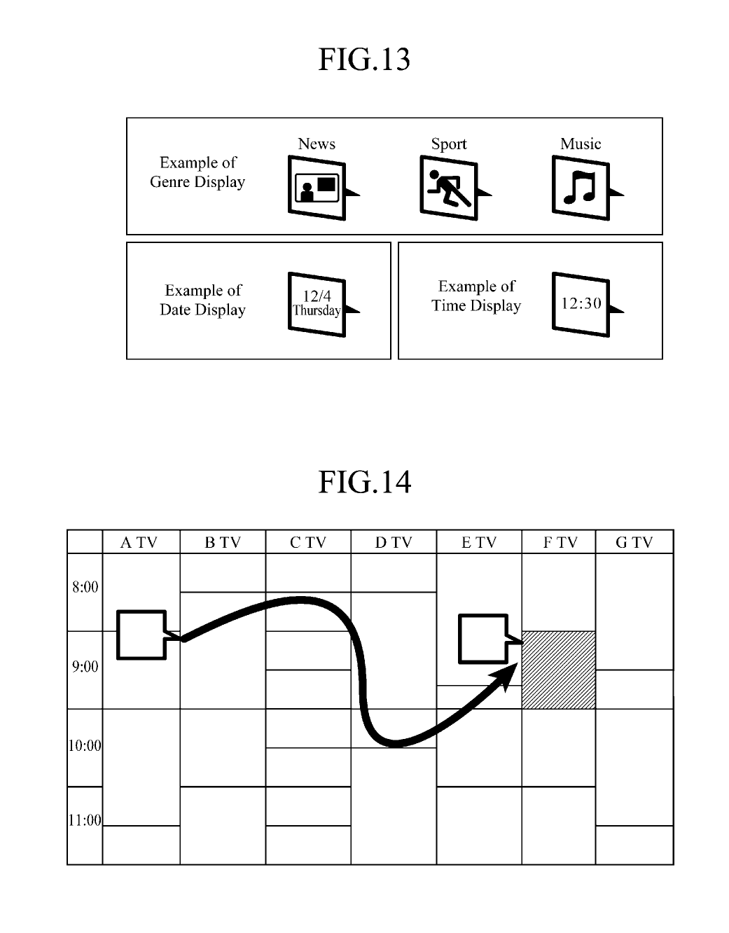

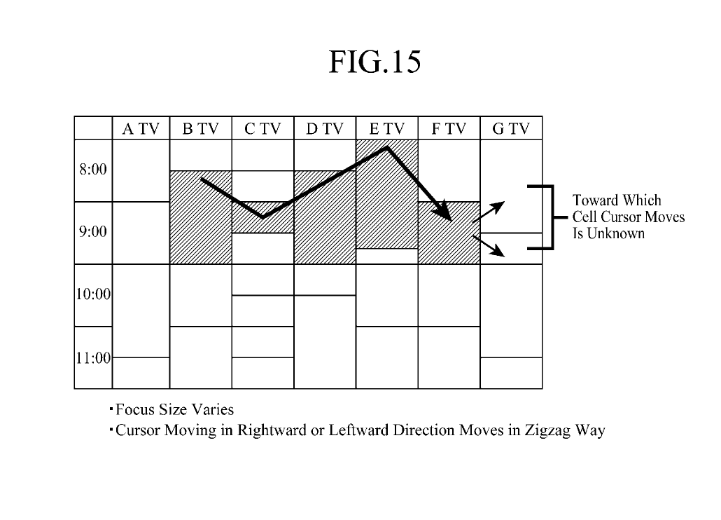

Although in above-mentioned Embodiments 1 to 4 the example in which the shape of the cursor is a right arrow, information associated with the program (e.g., the genre (e.g., news, sport, or music) of the program, the date of the program, the time of the program, etc.) can be displayed in the cursor, as shown in FIG. 13.

### Embodiment 6

Although in above-mentioned Embodiments 1 to 5 the example in which the user performs an operation of moving the cursor by using the remote control is shown, the operation equipment which the user uses to performs such an operation is not limited to the remote control. For example, the user can use operation equipment, such as a mouse, a touchpad, a joystick, or an optical camera. Because the user can move the cursor not only in the upward or downward direction and in the rightward or leftward direction but also in various directions by using such operation equipment, the user can use the cursor as a free cursor, as shown in FIG. 14.

While the invention has been described in its preferred embodiments, it is to be understood that an arbitrary combination of two or more of the above-mentioned embodiments can be made, various changes can be made in an arbitrary component according to any one of the above-mentioned embodiments, and an arbitrary component according to any one of the above-mentioned embodiments can be omitted within the scope of the invention.

What is claimed is:

1. A program guide display device comprising:
a program guide display unit for displaying an electronic program guide;
a cursor display unit for displaying a cursor which is a mark indicating a cell currently being selected from among cells associated with a plurality of programs which construct the electronic program guide displayed by said program guide display unit in a vicinity of said cell;
a moving operation receiving unit for receiving an operation of moving said cursor; and
a cursor control unit for, when a direction of movement of the operation received by said moving operation receiving unit is a rightward or leftward direction of said electronic program guide, outputting a command for moving a display position of said cursor in the rightward or leftward direction without changing a coordinate in an upward or downward direction of said cursor to said cursor display unit to change said cell currently being selected from one cell to another.

2. The program guide display device according to claim 1, wherein when the moving operation receiving unit does not receive an operation of moving the cursor during a fixed time interval after the cursor control unit outputs the command for moving the display position of the cursor in the rightward or leftward direction to the cursor display unit, the cursor control unit adjusts the coordinate in the upward or downward direction of the cursor.

3. The program guide display device according to claim 1, wherein when predicting that outputting the command for moving the display position of the cursor in the rightward or leftward direction to the cursor display unit to change the cell currently being selected from one cell to another will result in the other cell to which the current selection is changed going off a predetermined display area, the cursor control unit outputs a command for moving a display position of the electronic program guide in the rightward or leftward direction to the program guide display unit instead of outputting the command for moving the display position of said cursor in the rightward or leftward direction to said cursor display unit.

4. The program guide display device according to claim 1, when predicting that outputting the command for moving the display position of the cursor in the rightward or leftward direction to the cursor display unit to change the cell currently being selected from one cell to another will result in an upper or lower part of the other cell to which the current selection is changed going off a predetermined display area, the cursor control unit outputs a command for moving a display position of the electronic program guide in an upward or downward direction to the program guide display unit while outputting the command for moving the display position of said cursor in the rightward or leftward direction to said cursor display unit.

5. The program guide display device according to claim 4, wherein when a fixed time interval has elapsed after outputting the command for moving the display position of said cursor in the rightward or leftward direction to said cursor display unit, the cursor control unit outputs the command for moving the display position of the electronic program guide in the upward or downward direction to the program guide display unit.

6. The program guide display device according to claim 1, wherein the cursor display unit displays information associated with a corresponding program in the cursor.

7. A program guide display method comprising:
a program guide display processing step of a program guide display unit displaying an electronic program guide;
a cursor display processing step of a cursor display unit displaying a cursor which is a mark indicating a cell currently being selected from among cells associated with a plurality of programs which construct the electronic program guide displayed in said program guide display processing step in a vicinity of said cell;
a moving operation reception processing step of a moving operation receiving unit receiving an operation of moving said cursor; and
a cursor control processing step of, when a direction of movement of the operation received in said moving operation reception processing step is a rightward or leftward direction of said electronic program guide, a cursor control unit outputting a command for moving a display position of said cursor in the rightward or leftward direction without changing a coordinate in an upward or downward direction of said cursor to said cursor display unit to change said cell currently being selected from one cell to another.

8. A program guide display program for causing a computer to carry out:
a program guide display processing procedure for displaying an electronic program guide;
a cursor display processing procedure for displaying a cursor which is a mark indicating a cell currently being selected from among cells associated with a plurality of programs which construct the electronic program guide displayed according to said program guide display processing procedure in a vicinity of said cell;
a moving operation reception processing procedure for receiving an operation of moving said cursor; and
a cursor control processing procedure for, when a direction of movement of the operation received according to said moving operation reception processing procedure is a rightward or leftward direction of said electronic program guide, outputting a command for moving a display position of said cursor in the rightward or leftward direction without changing a coordinate in an upward or downward direction of said cursor to said cursor display processing procedure to change said cell currently being selected from one cell to another.
